(19) United States
(12) Patent Application Publication
(10) Pub. No.: US 2021/0002498 A1
(43) Pub. Date: Jan. 7, 2021

(54) OIL PAINTS RECYCLING

(71) Applicant: HUZAIFA HATIMBHAI MATAWALA, NEW YORK, NY (US)

(72) Inventor: HUZAIFA HATIMBHAI MATAWALA, NEW YORK, NY (US)

(21) Appl. No.: 17/029,605

(22) Filed: Sep. 23, 2020

Related U.S. Application Data
(63) Continuation-in-part of application No. 16/048,083, filed on Jul. 27, 2018.

(51) Int. Cl. C09D 7/80; C09D 5/00; C09D 5/08; C09D 7/42; C09D 17/00; C09D 1/04

(52) U.S. Cl. CPC C09D 7/80; C09D 5/006; C09D 1/04; C09D 7/42; C09D 17/007; C09D 5/084

(57) ABSTRACT

A method of making a liquid coating, the method comprising the steps of a) sorting and grouping compatible solvents and resins based on at least one of the following: sheen, color, density and gloss level to form an intermediate pulp; b) mixing alkyds and solvents with intermediate pulp to form a mixture; c) blending the mixture at an approximate speed of 1600 rpm; d) adding one or more of the following: pigment, solvent or alkyds to the mixture; and e) blending and filtering the mixture to form the homogenous liquid coating. The liquid coating includes a gloss alkyd enamel, an alkyd stain, a matte alkyd enamel, an anti-corrosive red oxide matte primer, an alkyd enamel having a semi-gloss/satin/egg-shell finish, a bitumen primer, a bitumen emulsion, an extra durable bitumen emulsion SBR, and a bitumen mastics (putty).

### CROSS-REFERENCE TO RELATED PATENT APPLICATIONS

This is a Continuation in Part (CIP) application of U.S. application Ser. No. 16/0480,083, filed Jul. 27, 2018, the disclosures of which are incorporated herein in their entirety by reference.

### TECHNICAL FIELD

This invention relates to a method of making a liquid coating using recycled oil-based paints. This invention also relates to the liquid coatings formed by the method. The liquid coatings include a gloss alkyd enamel, an alkyd stain, a matte alkyd enamel, an anti-corrosive red oxide matte primer, an alkyd enamel having a semi-gloss, satin, or egg-shell finish, a bitumen primer, a bitumen emulsion, an extra durable bitumen emulsion SBR, and a bitumen mastics (putty).

### BACKGROUND

The paint industry has entered into an era of continuous enhancement of chemistry from various perspectives of customer requirements, costs, environments, durability and reach. It is always challenging for a research and development team to create ecofriendly paints with proper costs and product performance. Every year millions of barrels of crude, hydrocarbons, and petrochemical raw materials are imported. Millions of gallons of these items are integrated into paint products.

Several formulations are edited and product is enhanced. With regards to paint formulations, the paint industry has changed more in the past decade than ever before. The changes leave us with several batches, raw materials, and stock of items that need to be replaced with newer ingredients. With the changes in environmental norms, the EPA laws, concerns with higher VOC paints and climatic and natural ecosystem impact of paints we deliver newer products in the market. This has occurred in factory store levels with several raw material industries in US, Canada and Europe. As the paint industry shifts to using the newer formulations, there is a growing amount of raw material and stock that is no longer usable to the industry. There are batches and items that cannot be utilized under the new rules and paint material manufacturers stuck with failed batches and obsolete raw materials that cannot be used.

Having experience in the industry with different type of resins, pigments, additives, solvents and paints, we developed a program to reuse the batch failures, obsolete materials, gelled batches, washed solvents, mis-tints, customer returns, non-usable, non-salable raw materials or paints of all type to use. Our attempt is to reduce the waste generation from the factory process itself by finding use for these items in our line of products. Once we are able to ascertain the chemistry, ingredients, compatibility, resin and solvent nature, the reuse of the items can be ascertained.

### SUMMARY

In one embodiment, the invention described herein is directed to a method of making a liquid coating. The method comprises the steps of:

a) sorting and grouping compatible solvents and resins based on at least one of the following: sheen, color, density and gloss level to form an intermediate pulp;

b) mixing alkyds and solvents with intermediate pulp to form a mixture;

c) blending the mixture at an approximate speed of 1600 rpm;

d) adding one or more of the following: pigment, solvent or alkyds to the mixture; and

e) blending and filtering the mixture to form the homogenous liquid coating.

Optionally, the method can further comprise step f) before step e), adding extenders into the mixture.

Optionally, the method can further comprise step g) before step e), adding red oxide pigment to the mixture.

In a second embodiment, the invention described herein is directed to a method of making a liquid coating comprising the steps of:

a) sorting and grouping compatible solvents and resins based on at least one of the following: sheen, color, density and gloss level to form an intermediate pulp;

b) mixing alkyds and solvents with the intermediate pulp to form a mixture;

c) blending the mixture at an approximate speed of 1600 rpm;

d) adding one or more of the following: pigment, solvent or alkyds to the mixture;

e) adding bitumen to the mixture;

f) adding extenders to the mixture;

g) adding black pigments to the mixture; and

h) blending and filtering the mixture to form the homogenous liquid coating.

Optionally, the method can further comprise step i) before step h), adding water to the mixture.

Optionally, the method can further comprise step j) before step h), adding bentonite to the mixture.

Optionally, the method can further comprise step k) before step h), adding styrene acrylic emulsion binder.

Optionally, the liquid coating made by the methods described above is a gloss alkyd enamel comprising:

a) intermediate pulp at 35-55%;

b) alkyds at 25-30%;

c) solvents at 10-20%;

d) driers at 1-2%;

e) anti-settling agents at 2%;

f) grinding media at 2%; and

g) pigment at 5-20%.

Optionally, the liquid coating made by the methods described above is an alkyd stain comprising:

a) intermediate pulp at 35-55%;

b) alkyds at 25-30%;

c) solvents at 10-20%;

d) driers at 1-2%;

e) anti-settling agents at 2%;

f) grinding media at 2%; and

g) pigment at 5-20%.

Optionally, the liquid coating made by the methods described above is a matte alkyd enamel comprising:

a) intermediate pulp at 35-50%;

b) alkyds at 15-25%;

c) solvents at 10-20%;

d) driers at 1-2%;

e) anti-settling agents at 2%;

f) grinding media at 2%;

g) pigment at 5-20%; and

h) extenders at 30-50%.

Optionally, the liquid coating made by the methods described above is an anti-corrosive red oxide matte primer comprising:

a) intermediate pulp at 35-50%;

b) alkyds at 15-25%;

c) solvents at 10-20%;

d) driers at 1-2%;

e) anti-settling agents at 2%;

f) grinding media at 2%;

g) pigment at 5-20%;

h) extenders at 30-50%; and

i) red oxide pigment at 5-20%.

Optionally, the liquid coating made by the methods described above is an alkyd enamel having a semi-gloss, satin, or egg shell finish, the alkyd enamel comprising:

a) intermediate pulp at 35-50%;

b) alkyds at 15-25%;

c) solvents at 10-20%;

d) driers at 1-2%;

e) anti-settling agents at 2%;

f) grinding media at 2%;

g) pigment at 5-20%; and

h) extenders at 10-20%

Optionally, the liquid coating made by the methods described above is a bitumen primer comprising:

a) intermediate pulp at 30-50%;

b) alkyds at 5-10%;

c) bitumen 60/70 at 10-25%

d) solvents at 10-20%;

e) driers at 1-2%;

f) anti-settling agents at 2%;

g) grinding media at 2%;

h) pigment at 5-20%;

i) extenders at 25-40%;

j) black oxide pigment at 5-10%; and

k) water at 0-40%.

Optionally, the liquid coating made by the methods described above is a bitumen emulsion comprising:

a) intermediate pulp at 20-30%;

b) alkyds at 5-10%;

c) bitumen 60/70 at 10-25%

d) solvents at 10-20%;

e) driers at 1-2%;

f) anti-settling agents at 2%;

g) grinding media at 2%;

h) pigment at 5-20%;

i) extenders at 25-40%;

j) black oxide pigment at 5-10%;

k) water at 20-40%; and

1) bentonite at 5-15%.

Optionally, the liquid coating made by the methods described above is an extra durable bitumen emulsion SBR comprising:

a) intermediate pulp at 20-30%;

b) bitumen 60/70 at 10-25%

c) solvents at 10-20%;

d) driers at 1-2%;

e) anti-settling agents at 2%;

f) grinding media at 2%;

g) pigment at 5-20%;

h) extenders at 25-40%;

i) black oxide pigment at 5-10%;

j) water at 20-40%;

k) bentonite at 5-15%; and

l) styrene acrylic emulsion at 5-15%.

Optionally, the liquid coating made by the methods described above is a bitumen mastics (putty) comprising:

a) intermediate pulp at 20-30%;

b) alkyds at 5-10%;

c) bitumen 60/70 at 10-25%

d) solvents at 1-20%;

e) driers at 1-2%;

f) anti-settling agents at 2%;

g) grinding media at 2%;

h) pigment at 5-20%;

i) extenders at 25-40%;

j) black oxide pigment at 5-10%; and

k) water at 10-20%.

Optionally, the driers comprise one or more of the following: cobalt, manganese, calcium and zirconium.

Optionally, the extenders comprise one or more of the following: talc, calcium carbonate, calcite, and silicate.

### DESCRIPTION

There is an extensive use of oil paints and solvents internationally as a durable easy solution. The advanced ecofriendly water-based formulations have not reached several countries across the globe and traditional solvent based coating system still provides an essential coating solution worldwide.

Successful solutions have been reached for reuse of latex based paints. With every passing year, humans are able to convert more and more cans of latex paints into a new recycled product. Used latex paint cans can be procured from the market, homes, industries and counties. These are typically used in stucco, plasters, driveway sealers and recycled latex based paints.

The current scenario of fuel blending and land burial impacts of oil paints on environment has been studied. A study was conducted, utilizing several manufacturers of paints, resin factories and paint recycling companies, to analyze oil paints and solvents and their reusability from a wider, global perspective.

When the lifecycle of paint is studied, from its origin to modifications including processes creating raw materials and the blending into a final paint product, how it effects the environmental system and how beneficial it is to reuse of oil paints, both economically and ecologically, is noted. The present invention provides a solution to save the solvent based paints.

As noted above, a study was performed. This was a detailed scientific study that took several years. Applicant has been working in the industry for 5 decades and is the third generation involved in recycling, manufacturing of paints and raw materials on multiple continents. The present invention is directed towards the current issue of how to handle/disposed of unused oil paints, resins, solvents, washed batches and rejections of Haz mat paint or raw materials to reusable solution. The solution is a process of recycling oil paints.

The use of these coatings are minimal in the developed countries, but can serve as a major help in the economies that need infrastructural development. The infrastructural zones of the developing countries can be served with the durable healthy products that are created from the solvents and oil paints. There are markets who use these items as an economical coating to protect the items.

Bitumen paints and several coatings that use the lower end resins and solvents in the formulations are primers that typically serve as an undercoat. Applicant replaced bitumen coat formulations with these recycled paints. Several primers for wood and metals have also been formulated. Salty, humid and extremely dry climates require a coat that protects the surface, prevents erosion on walls and keeps structures standing for longer. The formulations of the present invention have been tested in the market and been approved as they passed the necessary requirements and functions.

Fuel blending may be appropriate with the other petrochemicals or oils or flammable items. Solvent based paints like alkyd enamels, stains, sol based ink products, primers, paint thinners, tank washed solvents, alkyd resins, epoxies, hardner, etc. can also be reutilized, providing a cost savings, an ingredient savings, and environmental savings.

The present invention recycles, classifies, rectifies, and utilizes in a very cost efficient mat

The present invention is directed to a process of recycling oil paint to produce new recycled solvent based paint and resin formulations for use in the coating industry. The solvent based paints and resins are produced by the process outlined below. In order to determine the proper process, a study was performed directed to solvent and resin structure, compatibility, density, and boiling points.

### Solvents and Resin Compatibility Study

Solvents play a very important role in recycling paints and resins, as they determine the compatibility and the proper recycling facility the paint or resin will go to. If a manufacturing process is started without a proper understanding and study of how to recycle paints and resins, non-favorable batches are likely. Material may turn into cake like formations, lumps, chips, harden like rock or lose its viscosity. The possibility of performing a successful recycling of paint and resin is based on the study of the molecular structure, boiling paints, dispersing ability, and density of the solvent used in the paint or resin.

Because numerical values are used, comparisons can be made rationally by comparing numbers. For example, acetonitrile is much more polar than acetone but exhibits slightly less hydrogen bonding.

Based on a detailed study of the characteristics the bond of between the solvent and the resin, pigment metals and filler, we can ascertain how to use and break such bonds into newer or similar products for use.

For example, toluene and benzene solvents are more compatible with xylene than mineral spirits. However, xylene is compatible with mineral spirits as well. Certain solvents are soluble with each other, some are soluble to an extent only, some are completely non-soluble. Solvents when reacted with resins and pigments change the loyalty towards their house becoming more easily compatible most of the time. The use of additives, extenders and fillers play an important role.

### Process of Manufacturing Solvent Based Paints and Resins Using Recycled Paints and Resins

Once the groups of compatible solvents and resins are classified and grouped together, they are further sorted based on sheen, color, density, and level of gloss. Depending on the inventory, the products with common sheens, colors, and density are mixed together into batches forming an intermediate pulp. This is an important ingredient stage where the intermediate pulp is created from the oil paint, resin, solvent, pigment, waste/scrap/lots. These intermediate pulps are usually made while keeping in mind the usability for the final product. The batches of pulp are again checked for final gloss, resin-solvent-pigment-filler ratio on the basis of density, hardness, gloss, weight and viscosity.

The last step is manufacturing the final products, which can be floor paints, primer paints, stucco items, texture coatings, topcoats, Bitumen paints, etc. All of the formulations, blends, processes, and other ingredients in the mix remain an important part of chemistry. These various products can be sold under multiple brands in multiple markets to serve the markets with final recycled product that saved the important ingredients from land burial or fuel blending. It is also created without extraction of resources occurring in savings of energy thus environmentally beneficial.

All the batch making and production efforts are extremely essential stages where presence of mind and acute checks are needed all the time. The batches of pulps can have significant variances as to the properties due to the variety of mixes. The process needs to be very closely checked and examined during all stages to avoid production failures. If there is a production failure, time is wasted, and the failed batch again is kept for further rework. Such material is gradually mixed in dosages of small percentages in acceptable batches.

With the presence of the reactive chemistry in all the ingredients, over time, several components undergo changes in properties. The effect of exposure to climate, heat, cold, time, contamination and reactions with other items needs to be taken in consideration. Most of the reactive ingredients lose their power, however when the pulp batches and mixes are formulated, the following are considered: properties and capability to react, form compound, molecules and produce the desired product in return.

The scope of the present invention is recycling based on the requirement of paint reuse projects, cost/financial benefits, research and developments.

If the total cost of developing and disposing of paint is evaluated, the present invention can produce paint (using old paint that would otherwise have to be disposed of) at about half the cost. This is because the cost of disposal is no longer an issue as the paint can be recycled.

Processes and cost of obtaining the paint from nature is saved when paint is reused. For example, when resins are cooked in a reactor with the amines, natural agricultural oils, phallic anahydrides, penta, maelic and monomers, the process utilizes energy, resources, power and rare blends of nature. If we are able to reuse the paint, we save the ingredients and the energy that were to be spent on creation of those raw materials.

On the contrary, when these items are disposed of in a fire, the ingredients cannot be saved and reused. The cycle of generation of newer resins, solvents, metallic driers, pigments, additives, etc. has to take place. If old paints are not recycled, more raw materials must be extracted from the earth. For example, more gums from more trees, mountains are eroded for minerals, oils are extracted from the sea to create specialty monomers and hydrocarbons to attain solvent based paints. Such saving is much more in value and utility than the fuel blending properties a paint can will provide. Also, in most of the cases the paints of certain grades do not help the burning process and in-fact hamper the fuel blending costings.

Formulations

Formulation 1: Gloss Alkyd Enamels from Recycled Items

| INGREDIENTS | PERCENTAGE |
|---|---|
| BULKED SOLVENT BASED RECYCLED PAINTS | 35-55% |
| ALKYDS | 25-30% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |

First, alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain the desired gloss, solid in percentages and durability aspects of the final products.

Next, the mixture is blended and filtered until the final product is a homogenous perfect shade, grind, gloss, dry, and hardness.

Formulation 2: Alkyd Stains from Recycled Items

| INGREDIENTS | PERCENTAGE |
|---|---|
| BULKED SOLVENT BASED RECYCLED PAINTS | 35-55% |
| ALKYDS | 25-30% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |

Preferably, clear and light-colored bulked items are used to get the alkyd stains. First, the alkyds and solvents are mixed with the bulked solvent based recycled paints (intermediate pulp). Pigments, solvents and alkyds are added as necessary to obtain the desired gloss, solid in percentages and durability aspects of the final products.

Next, the mixture is blended and filtered until the final product is a homogenous perfect shade, grind, gloss, dry, and hardness.

Formulation 3: Matte Alkyd Enamels from Recycled Items

| INGREDIENTS | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 30-50% |
| (Talc, calcium carbonate, calcite, silicate) | |

First, the alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain the desired gloss, solid in percentages and durability aspects of the final products.

Next, extenders are gradually mixed into mixture to obtain a matte finish in the paint.

And finally, the mixture is blended and filtered until the final product is a homogenous perfect shade, grind, gloss, dry, and hardness.

Formulation 4: Anti Corrosive Red Oxide Matte Primer from Recycled Items

| INGREDIENTS | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 20-30% |
| (Talc, calcium carbonate, calcite, silicate) | |
| RED OXIDE PIGMENT | 5-20% |

First, the alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain the desired gloss, solid in percentages and durability aspects of the final products.

Next, extenders are gradually mixed into the mixture to obtain a matte finish in the paint.

Next, red oxide pigment is added to the mixture to achieve the anticorrosive feature to the paint.

And finally, the mixture is blended and filtered until the final product is a homogenous perfect shade, grind, gloss, dry, and hardness.

Formulation 5: Semi Gloss/Satin/Egg Shell Finishes of Alkyd Enamels from Recycled Items

| INGREDIENTS | PERCENTAGE |
|---|---|
| BULKED SOLVENT BASED RECYCLED PAINTS | 35-50% |
| ALKYDS | 15-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 10-20% |
| (Talc, calcium carbonate, calcite, silicate) | |

First, the alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain the desired gloss, solid in percentages and durability aspects of the final products.

Next, extenders are gradually mixed into the mixture to obtain the desired finish in the paint. The more extended added, the more the sheen gets reduced.

And finally, the mixture is blended and filtered until the final product is a homogenous perfect shade, grind, gloss, dry, and hardness.

Formulation 6: Bitumen Primer from Recycled Items

| INGREDIENTS | PERCENTAGE |
|---|---|
| BULKED SOLVENT BASED RECYCLED PAINTS | 30-50% |
| ALKYDS | 5-10% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 0-40% |

First, alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain the desired gloss, solid in percentages and durability aspects of the final products.

Next, bitumen is mixed in hot form into the mixture.

Next, extenders are gradually mixed into the mixture to obtain a matte finish in the paint.

Next, black pigments are mixed into the mixture to obtain the jet-black color required to manufacture the primer.

Water can be added compatible and acceptable to the current batch.

The addition of water effects the sheen, durability, hardness, drying capability of the paint.

The addition of water is however not recommended even though it reduces the cost of the final product.

And finally, the mixture is blended and filtered until the final product is a homogenous perfect shade, grind, gloss, dry, and hardness.

A variety of solvents, epoxies, industrial coatings can be used in batches of bitumen paints.

Formulation 7: Bitumen Emulsion from Recycled Items

| INGREDIENTS | PERCENTAGE |
|---|---|
| BULKED SOLVENT BASED RECYCLED PAINTS | 20-30% |
| ALKYDS | 5-10% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 20-40% |
| BENTONITE | 5-15% |

First, alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain desired gloss, solid in percentages and durability aspects of the final products.

Next, bitumen is mixed in hot form into the mixture.

Next, extenders are gradually mixed into the mixture to obtain a matte finish in the paint.

Next, black pigments are mixed into the mixture to obtain the jet black color required to manufacture the primer.

Bentonite can be added to the mixture to enhance the acceptability of water with solvent based items.

Water can be added to the extent compatible and acceptable to the current batch.

The addition of water effects the sheen, durability, hardness, drying capability of the paint.

The addition of water is however not recommended even though it reduces the cost of the final product.

And finally, the mixture is blended and filtered until the final product is a homogenous perfect shade, grind, gloss, dry, and hardness.

This is a primer product that is water based in nature with durability of bitumen as a resin.

A variety of solvents, epoxies, industrial coatings can be used in batches of bitumen paints.

Formulation 8: Extra Durable Bitumen Emulsion SBR from Recycled Items

| INGREDIENTS | PERCENTAGE |
|---|---|
| BULKED SOLVENT BASED RECYCLED PAINTS | 20-30% |
| BITUMEN 60/70 | 10-25% |
| SOLVENTS | 10-20% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, calcium carbonate, calcite, silicate) | |
| BLACK OXIDE PIGMENT | 5-10% |
| WATER | 20-40% |
| BENTONITE | 5-15% |
| STYRENE ACRYLIC EMULSION | 5-15% |

First, alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain desired gloss, solid in percentages and durability aspects of the final products.

Next, bitumen is mixed in hot form into the mixture.

Next, extenders are gradually mixed into the mixture to obtain a matte finish in the paint.

Next, black pigments are mixed into the mixture to obtain the jet black color required to manufacture the primer.

Bentonite can be added to the mixture to enhance the acceptability of water with solvent based items.

Water can be added to the extent compatible and acceptable to the current batch.

The addition of water effects the sheen, durability, hardness, drying capability of the paint.

The addition of water is however not recommended even though it reduces the cost of the final product.

And finally, the mixture is blended and filtered until the final product is a homogenous perfect shade, grind, gloss, dry, and hardness.

This is a primer product that is water based in nature with durability of bitumen as a resin.

The use of styrene acrylic emulsion binder is essential to obtain the extra durability.

A variety of solvents, epoxies, industrial coatings can be used in batches of bitumen paints.

Formulation 9: Bitumen Mastics (Putty) from Recycled Items

| INGREDIENTS | PERCENTAGE |
|---|---|
| BULKED SOLVENT BASED RECYCLED PAINTS | 20-30% |
| ALKYDS | 5-10% |
| BITUMEN 60/70 | 10-25% |
| SOLVENTS | 1-25% |
| DRIERS | 1%-2% |
| cobalt | |
| manganese | |
| calcium | |
| zirconium | |
| ANTI SETTLING AGENTS | 2% |
| GRINDING MEDIA | 2% |
| PIGMENT | 5%-20% |
| EXTENDERS | 25-40% |
| (Talc, china clay, calcium carbonate, calcite, silicate) | |
| BLACK OXIDE PIGMENT | 5-10% |
| WATER | 10-20% |

First, alkyds and solvents are mixed with the bulked solvent based recycled paints (intermediate pulp). High-speed stirrers are used to blend the mixture at an approximate speed of 1600 rpm. Pigments, solvents and alkyds are added as necessary to obtain desired gloss, solid in percentages and durability aspects of the final products.

Next, bitumen is mixed in hot form into the mixture.

Next, extenders are gradually mixed into the mixture to obtain a matte finish in the paint.

Next, black pigments are mixed into the mixture to obtain the jet-black color required to manufacture the primer.

Water is a part of the process and it is essential part of chemistry.

And finally, the mixture is blended and filtered until the final product is a homogenous perfect shade, grind, gloss, dry, and hardness.

Mastics and putty are used to fill in the cracks of the ceiling, walls, between the tiles.

A variety of solvents, epoxies, industrial coatings can be used in batches of bitumen paints.

In summary, the present invention produces two major solutions.

One, reuse and control of the damage paints can cause to environment.

And two, secure the petrochemical resources, causing multibillion savings on the importations of petrochemical raw materials.

1. A method of making a liquid coating comprising the steps of:
a) sorting and grouping compatible solvents and resins based on at least one of the following: sheen, color, density and gloss level to form an intermediate pulp;
b) mixing alkyds and solvents with intermediate pulp to form a mixture;
c) blending the mixture at an approximate speed of 1600 rpm;
d) adding one or more of the following: pigment, solvent or alkyds to the mixture; and
e) blending and filtering the mixture to form the homogenous liquid coating.

2. The method of claim 1, wherein the liquid coating is a gloss alkyd enamel comprising:
a) intermediate pulp at 35-55%;
b) alkyds at 25-30%;
c) solvents at 10-20%;
d) driers at 1-2%;
e) anti-settling agents at 2%;
f) grinding media at 2%; and
g) pigment at 5-20%.

3. The method of claim 2, wherein the driers comprise one or more of the following: cobalt, manganese, calcium and zirconium.

4. The method of claim 1, wherein the liquid coating is an alkyd stain comprising:
a) intermediate pulp at 35-55%;
b) alkyds at 25-30%;
c) solvents at 10-20%;
d) driers at 1-2%;
e) anti-settling agents at 2%;
f) grinding media at 2%; and
g) pigment at 5-20%.

5. The method of claim 4, wherein the driers comprise one or more of the following: cobalt, manganese, calcium and zirconium.

6. The method of claim 1, further comprising step f) before step e), adding extenders into the mixture.

7. The method of claim 6, wherein the liquid coating is a matte alkyd enamel comprising:
a) intermediate pulp at 35-50%;
b) alkyds at 15-25%;
c) solvents at 10-20%;
d) driers at 1-2%;
e) anti-settling agents at 2%;
f) grinding media at 2%;
g) pigment at 5-20%; and
h) extenders at 30-50%.

8. The method of claim 6, further comprising step g) before step e), adding red oxide pigment to the mixture.

9. The method of claim 8, wherein the liquid coating is an anti-corrosive red oxide matte primer comprising:
a) intermediate pulp at 35-50%;
b) alkyds at 15-25%;
c) solvents at 10-20%;
d) driers at 1-2%;
e) anti-settling agents at 2%;
f) grinding media at 2%;
g) pigment at 5-20%;
h) extenders at 30-50%; and
i) red oxide pigment at 5-20%.

10. The method of claim 9, wherein the driers comprise one or more of the following: cobalt, manganese, calcium and zirconium.

11. The method of claim 9, wherein the extenders comprise one or more of the following: talc, calcium carbonate, calcite, and silicate.

12. The method of claim 6, wherein the liquid coating is an alkyd enamel having a semi-gloss, satin, or egg shell finish, the alkyd enamel comprising:
a) intermediate pulp at 35-50%;
b) alkyds at 15-25%;
c) solvents at 10-20%;
d) driers at 1-2%;
e) anti-settling agents at 2%;
f) grinding media at 2%;
g) pigment at 5-20%; and
h) extenders at 10-20%.

13. A method of making a liquid coating comprising the steps of:
a) sorting and grouping compatible solvents and resins based on at least one of the following: sheen, color, density and gloss level to form an intermediate pulp;
b) mixing alkyds and solvents with the intermediate pulp to form a mixture;
c) blending the mixture at an approximate speed of 1600 rpm;
d) adding one or more of the following: pigment, solvent or alkyds to the mixture;
e) adding bitumen to the mixture;
f) adding extenders to the mixture;
g) adding black pigments to the mixture; and
h) blending and filtering the mixture to form the homogenous liquid coating.

14. The method of claim 13, further comprising step i) before step h), adding water to the mixture.

15. The method of claim 13, wherein the liquid coating is a bitumen primer comprising:
a) intermediate pulp at 30-50%;
b) alkyds at 5-10%;
c) bitumen 60/70 at 10-25%
d) solvents at 10-20%;
e) driers at 1-2%;
f) anti-settling agents at 2%;
g) grinding media at 2%;
h) pigment at 5-20%;
i) extenders at 25-40%;
j) black oxide pigment at 5-10%; and
k) water at 0-40%.

16. The method of claim 14, further comprising step j) before step h), adding bentonite to the mixture.

17. The method of claim 16, wherein the liquid coating is a bitumen emulsion comprising:
a) intermediate pulp at 20-30%;
b) alkyds at 5-10%;
c) bitumen 60/70 at 10-25%
d) solvents at 10-20%;
e) driers at 1-2%;
f) anti-settling agents at 2%;
g) grinding media at 2%;
h) pigment at 5-20%;
i) extenders at 25-40%;
j) black oxide pigment at 5-10%;
k) water at 20-40%; and
l) bentonite at 5-15%.

18. The method of claim 16, further comprising step k) before step h), adding styrene acrylic emulsion binder.

19. The method of claim 18, wherein the liquid coating is an extra durable bitumen emulsion SBR comprising:
a) intermediate pulp at 20-30%;
b) bitumen 60/70 at 10-25%
c) solvents at 10-20%;
d) driers at 1-2%;
e) anti-settling agents at 2%;
f) grinding media at 2%;
g) pigment at 5-20%;
h) extenders at 25-40%;
i) black oxide pigment at 5-10%;
j) water at 20-40%;
k) bentonite at 5-15%; and
l) styrene acrylic emulsion at 5-15%.

20. The method of claim 13, wherein the liquid coating is a bitumen mastics (putty) comprising:
a) intermediate pulp at 20-30%;
b) alkyds at 5-10%;
c) bitumen 60/70 at 10-25%
d) solvents at 1-20%;
e) driers at 1-2%;
f) anti-settling agents at 2%;
g) grinding media at 2%;
h) pigment at 5-20%;
i) extenders at 25-40%;
j) black oxide pigment at 5-10%; and
k) water at 10-20%.
